(19) United States
(12) Patent Application Publication
(10) Pub. No.: US 2021/0112814 A1
(43) Pub. Date: Apr. 22, 2021

(54) ANTIBACTERIAL ANTIFUNGAL FIBER STRUCTURE

(71) Applicant: OSAKA KASEI CO., LTD., Osaka-shi, Osaka (JP)

(72) Inventor: Osamu Goushi, Osaka-shi (JP)

(73) Assignee: OSAKA KASEI CO., LTD., Osaka-shi, Osaka (JP)

(21) Appl. No.: 16/981,786

(22) PCT Filed: Mar. 22, 2019
(86) PCT No.: PCT/JP2019/012281

§ 371 Date: Sep. 17, 2020

(30) Foreign Application Priority Data
Mar. 30, 2018 (JP) 2018-068668

(51) Int. Cl. A01N 59/16; A01N 25/10; A01N 25/24; A01N 25/30

(52) U.S. Cl. CPC A01N 59/16; A01N 25/10; A01N 2300/00; A01N 25/30; A01N 25/24

(57) ABSTRACT

An antibacterial antifungal fiber structure is provided, which comprises a polyester mixed fiber structure, and an antibacterial antifungal agent (A) and an antibacterial antifungal agent fixation aid (B) contained in the polyester mixed fiber structure, wherein the antibacterial antifungal agent (A) comprises a pyridine antibacterial antifungal agent, wherein the antibacterial antifungal agent fixation aid (B) comprises at least one compound selected from a first group (b1) comprising a surfactant, a second group (b2) comprising an organic solvent, and a third group (b3) comprising an aromatic compound and a urea compound. The antibacterial antifungal fiber structure is excellent in antibacterial and antifungal properties because the antibacterial antifungal agent (A) is fixed together with the antibacterial antifungal agent fixation aid (B) in fibers of the polyester mixed fiber structure.

### TECHNICAL FIELD

The present disclosure relates to an antibacterial antifungal fiber structure excellent in washing durability.

### BACKGROUND ART

With recent higher awareness of hygiene and health, clothes, towels, bedclothes, and other personal fiber products imparted with antibacterial and antifungal properties have prevailed in the market. However, many antibacterial antifungal agents cannot be easily chemically bonded to fibers. Therefore, the fiber products are mostly imparted with the antibacterial and antifungal properties simply by coating fiber surfaces with an antibacterial antifungal agent with the use of a binder such as a resin. For this reason, the antibacterial antifungal agent is liable to be detached from the fiber surfaces when such a fiber product is repeatedly washed. Therefore, the antibacterial and antifungal properties are problematically deteriorated every time the fiber product is washed. On the other hand, synthetic fiber products produced from synthetic fibers prepared by spinning a resin kneaded with the antibacterial antifungal agent have also prevailed in the market. However, a very few number of antibacterial agents can withstand the temperatures for the kneading and the spinning (not lower than 300° C. for polyesters). Further, where an inorganic antibacterial agent having a higher heat resistance is contained in synthetic fibers, the inorganic antibacterial agent is unlikely to bleed, failing to sufficiently exhibit its antibacterial and antifungal properties.

Incidentally, polyester fibers are excellent in heat resistance, and are often subjected to a dyeing treatment by a high-pressure high-temperature process or a normal-pressure high-temperature process (so-called baking process). An exemplary method for imparting a polyester fiber product with washing-durable antibacterial and antifungal properties is proposed, in which the polyester fiber product is immersed in a dispersion of a pyridine antibacterial antifungal agent, and subjected to a high-temperature heat treatment at 170° C. to 190° C. under atmospheric pressure in air to thereby loosen dense amorphous portions of the polyester and allow the pyridine antibacterial antifungal agent to infiltrate into the resulting interstices of the amorphous portions for fixation of the pyridine antibacterial antifungal agent (see PTL 1).

PTL 2 and PTL 3 propose that, where the antibacterial property is insufficient, an auxiliary antibacterial agent is used in combination with the pyridine antibacterial agent to provide a synergistic effect. Particularly, PTL 2 proposes that at least one auxiliary antibacterial agent selected from the group consisting of a carboxylic acid compound, a phenol compound, and a urea compound is used in combination with the pyridine antibacterial agent to provide a synergistic effect for the antibacterial property of the fiber structure. That is, where the polyester fibers are thermally impregnated with the pyridine antibacterial agent at a temperature of not lower than 180° C. in air, the utilization efficiency of the pyridine antibacterial agent is 90% or higher and, therefore, the fixation amount of the pyridine antibacterial agent is not increased any more. For improvement of the antibacterial effect under lower humidity conditions, the auxiliary antibacterial agent is blended in an amount of not less than 0.01 wt. % (100 mg/kg) to provide the synergistic effect of the pyridine antibacterial agent and the auxiliary antibacterial agent for the antibacterial property.

In PTL 2, it is verified that single-component fibers such as acryl fibers or nylon fibers having a lower heat resistance can be properly treated at a temperature suitable for the fibers, but no verification is made on polyester mixed fibers including polyester fibers and the acryl fibers or the nylon fibers having a lower heat resistance. That is, it is not verified whether the efficiency of the fixation of the pyridine antibacterial agent to the polyester mixed fibers is improved simply by performing the treatment at a relatively low temperature, i.e., 150° C. or lower. Thus, PTL 2 teaches nothing about the effect for promoting the fixation of the pyridine antibacterial agent in the polyester mixed fibers. In Examples in PTL 2, a surfactant and a solvent are used in combination for dispersing and solubilizing the auxiliary antibacterial agent in water, but no verification is made on the synergistic effect of the combinational use for the improvement of the fixation efficiency, and the effect of the combinational use for the promotion of the fixation of the pyridine antibacterial agent in the fibers.

On the other hand, NPL 1 reports that the rate of dye diffusion to the polyester fibers is improved with the use of phenylphenol. However, this study is originally directed to a dye synthesized to be imparted with a higher affinity for the polyester fibers, but no verification is made on the pyridine antibacterial antifungal agent having a lower affinity for the polyester fibers. In addition, the synergistic effect of the combinational use with the auxiliary agent is not sufficiently verified.

### RELATED ART DOCUMENTS

### Patent Documents

PTL 1: JP-A-2000-8275
PTL 2: JP-A-2007-126778
PTL 3: JP-A-HEI10 (1998)-509171

### Non-Patent Document

NPL 1: Journal of Chemical Society of Japan, 1972, p 127-132

### SUMMARY

According to PTL 1 and PTL 2, as described above, the antibacterial agent can be effectively applied to the fiber product of 100% polyester fibers at a high temperature, i.e., 170° C. or higher. Recently, mixed fibers prepared by blending polyester fibers and other fibers (of polyurethane, polyamide, acryl, cotton, or the like) for improvement of stretchability and body feeling property have prevailed in the market. The conventional techniques can be used to impart the mixed fibers with the antibacterial and antifungal properties, but cannot be used for practical applications because problems such as texture deterioration and discoloration are liable to occur. Similarly, yarns and fabrics produced by using yarns of polyester fibers and yarns of other fibers in combination are liable to suffer from the same problems.

That is, a fiber structure produced by combining fibers of polyurethane, polyamide, acryl or cotton and the polyester fibers (hereinafter referred to generally as “polyester mixed fiber structure”) is susceptible to discoloration, hardening or fiber fusion when being subjected to a high-temperature treatment at a temperature of 160° C. or higher. This may result in poorer appearance and texture. For this reason, the polyester mixed fiber structure needs to be treated at a relatively low temperature, i.e., at about 150° C. or lower. Where the polyester mixed fiber structure is treated at a temperature of not higher than 150° C., however, the amorphous portions of the polyester fibers are not sufficiently loosened, and have poorer molecular motion. Therefore, it is impossible to fix the pyridine antibacterial antifungal agent (having a higher molecular weight and less reactive with the fibers) in the fibers in a short period of time and, hence, to impart the polyester mixed fiber structure with washing-durable antibacterial and antifungal properties.

The term “fixation” or “fix” as used herein means that the pyridine antibacterial antifungal agent infiltrates into the synthetic fibers, and the pyridine antibacterial antifungal agent simply adhering to the fiber surfaces is excluded. The fixed antibacterial antifungal agent can be analyzed after the antibacterial antifungal agent adhering to the fiber surfaces is removed by washing or the like.

Incidentally, when the pyridine antibacterial antifungal agent (specifically, zinc pyrithione or so-called ZPT) is applied at a predetermined concentration and fixed to the polyester fibers by the baking process, the treatment temperature and the fixation ratio (the percentage (%) of ZPT fixed in the fibers with respect to ZPT contained in a treatment liquid and adhering to the fibers) have a relationship as shown in a graph of FIG. 2A, in which a solid line indicates the conventional case.

This graph indicates that the ZPT fixation ratio (=(Amount of ZPT contained in fibers)/(Amount of ZPT used for treatment) in this case) is 80% when the treatment temperature is 170° C., and is about 90% when the treatment temperature is 180° C. When the treatment temperature is 150° C., in contrast, ZPT can hardly be fixed in the fibers with a fixation ratio of about 20%. As indicated by a broken line in FIG. 2A, it is strongly desired to improve the fixation ratio even at a treatment temperature of 150° C.

It is supposed that the ZPT fixation amount may be increased by increasing the ZPT concentration of the treatment liquid. However, the amorphous portions of the polyester fibers are not sufficiently loosened at a lower treatment temperature on the order of 150° C. Therefore, as shown in FIG. 2B, the fixation amount is hardly increased even if the ZPT concentration is increased. Where the treatment is performed at a treatment temperature of 180° C., on the other hand, the amorphous portions of the polyester fibers are loosened to expend the interstices of the fibers into which ZPT infiltrates and, therefore, the fixation amount can be increased by increasing the ZPT concentration.

In view of the foregoing, the present disclosure provides a washing-durable antibacterial antifungal polyester mixed fiber structure which is produced through a treatment at a relatively low temperature, e.g., about 150° C., under atmospheric pressure, but yet contains a sufficient amount of an antibacterial antifungal agent fixed therein.

According to a first aspect of the present disclosure to solve the aforementioned problems, there is provided an antibacterial antifungal fiber structure, which comprises a polyester mixed fiber structure, the polyester mixed fiber structure comprising a polyester fiber and at least one non-polyester fiber, and an antibacterial antifungal agent (A) and an antibacterial antifungal agent fixation aid (B) contained in the polyester mixed fiber structure, wherein the antibacterial antifungal agent (A) is a pyridine antibacterial antifungal agent, wherein the antibacterial antifungal agent fixation aid (B) comprises at least one compound selected from: (b1) a first group comprising a surfactant; (b2) a second group comprising an organic solvent; and (b3) a third group comprising an aromatic compound and a urea compound, wherein the antibacterial antifungal agent (A) is fixed together with the antibacterial antifungal agent fixation aid (B) in fibers of the polyester mixed fiber structure.

According to a second aspect of the present disclosure, in particular, the antibacterial antifungal agent (A) is present in an amount of 200 to 20,000 mg/kg based on the weight of the overall antibacterial antifungal fiber structure, and the antibacterial antifungal agent fixation aid (B) is present in an amount of 1 to 500 mg/kg based on the weight of the overall antibacterial antifungal fiber structure. According to a third aspect of the present disclosure, the antibacterial antifungal agent (A) comprises a pyridine metal complex in the antibacterial antifungal fiber structure.

According to a fourth aspect of the present disclosure, the first group (b1) of the antibacterial antifungal agent fixation aid (B) comprises at least one selected from surfactants represented by the following formulae (1) and (2) in the antibacterial antifungal fiber structure.

R¹—O—(R²O)ₙ—H (1)

wherein R¹ is C₈ to C₁₈ alkyl group, and R² is alkylene group.

ϕ-O—(R³O)ₙ—H (2)

wherein ϕ is polycyclic phenyl group, and R³ is alkylene group.

According to a fifth aspect of the present disclosure, the third group (b3) of the antibacterial antifungal agent fixation aid (B) comprises at least one selected from the group consisting of aromatic compounds and urea compounds represented by the following formulae (3) to (8) in the antibacterial antifungal fiber structure.

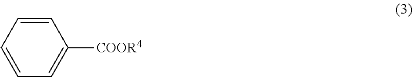

wherein R⁴ is alkyl group.

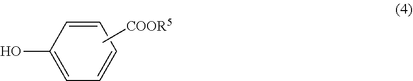

wherein R⁵ is alkyl group.

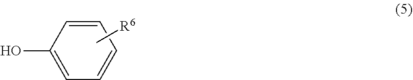

wherein R⁶ is alkyl group.

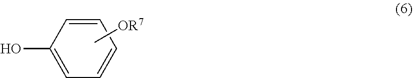

wherein R⁷ is alkyl group.

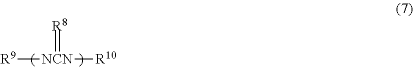

wherein R⁸ is oxygen atom or sulfur atom, and R⁹ and R¹⁰ are each alkyl group or hydrogen atom.

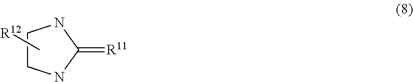

wherein R¹¹ is oxygen atom or sulfur atom, and R¹² is alkyl group or hydrogen atom.

According to a sixth aspect of the present disclosure, in particular, the antibacterial antifungal agent fixation aid (B) comprises at least two compounds selected from among all compounds of the first group (b1), the second group (b2), and the third group (b3) in the antibacterial antifungal fiber structure.

According to a seventh aspect of the present disclosure, in particular, the antibacterial antifungal agent fixation aid (B) comprises at least one compound selected from the first group (b1) and at least one compound selected from the second group (b2) in the antibacterial antifungal fiber structure.

According to an eighth aspect of the present disclosure, in particular, the antibacterial antifungal agent fixation aid (B) comprises at least one compound selected from the first group (b1) and at least one compound selected from the third group (b3) in the antibacterial antifungal fiber structure.

According to a ninth aspect of the present disclosure, in particular, the antibacterial antifungal agent fixation aid (B) comprises at least one compound selected from the second group (b2) and at least one compound selected from the third group (b3) in the antibacterial antifungal fiber structure.

According to a tenth aspect of the present disclosure, in particular, the antibacterial antifungal agent fixation aid (B) comprises at least one compound selected from the first group (b1), at least one compound selected from the second group (b2), and at least one compound selected from the third group (b3) in the antibacterial antifungal fiber structure.

The antibacterial antifungal fiber structure according to the present disclosure comprises the pyridine antibacterial antifungal agent as the antibacterial antifungal agent (A), and at least one compound selected from the first group (b1) comprising a surfactant, the second group (b2) comprising an organic solvent, and the third group (b3) comprising an aromatic compound and a urea compound as the antibacterial antifungal agent fixation aid (B). The antibacterial antifungal fiber structure comprises the polyester mixed fiber structure, which includes polyester fibers in combination with synthetic fibers such as of polyurethane, polyamide or acryl, semisynthetic fibers such as of cellulose or acetate, or natural fibers such as of cotton, silk or wool, which have a lower heat resistance. The antibacterial antifungal agent (A) is fixed together with the antibacterial antifungal agent fixation aid (B) in the fibers of the mixed fiber structure.

The polyester fibers have a feature such that the molecular chain motion of the polyester is enhanced at a temperature higher than the glass transition temperature of the polyester (70° C. or higher for most polyester fibers) to expand the interstices of the amorphous portions of the polyester. At a higher temperature, the molecular chain motion of the polyester is more liable to be enhanced, and the interstices of the amorphous portions are more liable to be expanded. Where a dye, an antibacterial agent or the like is allowed to infiltrate into the polyester fibers in air by a normal-pressure high-temperature treatment, it is generally necessary to achieve the infiltration of the dye, the antibacterial agent or the like into the fibers in a short period of time. Therefore, the antibacterial agent is allowed to infiltrate into the fibers in a short period of time on the order of several tens of seconds to several minutes by performing the treatment at a high temperature that is equal to the glass transition temperature (70° C.) plus 100° C. or more (i.e., 170° C. or higher). However, it is impossible to allow the antibacterial agent or the like to sufficiently infiltrate into the fibers at a relatively low temperature (e.g., 150° C.) in a short period of time on the order of several minutes.

In the present disclosure, the infiltration of the antibacterial antifungal agent (A) into the polyester fibers can be promoted even by the treatment at the relatively low temperature with the use of the specific antibacterial antifungal agent fixation aid (B).

Where the surfactant is used as the antibacterial antifungal agent fixation aid (B), more specifically, the surface energy of the fibers is changed by the surfactant to increase the affinity of the pyridine antibacterial antifungal agent for the fiber surfaces. Thus, the antibacterial antifungal agent fixation aid (B) has an effect for selectively increasing the existence probability of the pyridine antibacterial antifungal agent on around the fiber surfaces, and an effect for introducing the pyridine antibacterial antifungal agent into the polyester fibers, thereby assisting the infiltration of the antibacterial antifungal agent.

Where the organic solvent is used as the antibacterial antifungal agent fixation aid (B), the organic solvent has an effect for increasing the solute concentration of the pyridine antibacterial antifungal agent (which has poorer water solubility) in the treatment liquid, whereby the infiltration rate of the pyridine antibacterial antifungal agent is increased.

Where the aromatic compound or the urea compound is used as the antibacterial antifungal agent fixation aid (B), the compound infiltrates into the polyester fibers, thereby enhancing the molecular chain motion in the amorphous portions of the polyester fibers and expanding the interstices of the amorphous portions. Thus, the compound has an effect for increasing the infiltration rate of the antibacterial agent and the like.

Conventionally, the antibacterial agent or the like can be fixed in the polyester fibers only at a high temperature on the order of 180° C. or higher in a short period of time. In the present disclosure, in contrast, the three infiltration promoting effects are provided alone or in combination, whereby the pyridine antibacterial antifungal agent can be efficiently fixed in the fibers at a relatively low temperature in a short period of time.

The antibacterial antifungal fiber structure of the present disclosure comprises the polyester mixed fiber structure including the polyester fibers (which are conventionally infiltrated with the antibacterial antifungal agent (A) only by the high-temperature treatment in air at 180° C. or higher under atmospheric pressure), and the less heat-resistant fibers such as of polyurethane, polyamide or acryl in combination. Since the antibacterial antifungal agent (A) is sufficiently infiltration-fixed together with the antibacterial antifungal agent fixation aid (B) into the fibers of the polyester mixed fiber structure even without performing the high-temperature treatment in air at 180° C. or higher, the antibacterial antifungal fiber structure is excellent in antibacterial and antifungal properties. In addition, the antibacterial and antifungal properties are highly washing-durable. Without the need for the higher-temperature treatment at 180° C., the fibers are less susceptible to thermal damage, and advantageously have excellent texture.

In particular, the pyridine antibacterial antifungal agent to be used as the antibacterial antifungal agent (A) in the present disclosure has sufficient antibacterial properties even against highly drug-resistant bacteria such as methicillin-resistant Staphylococcus aureus (so-called MRSA) and vancomycin-resistant enterococcus (VRE). Therefore, the fiber structure is suitable for applications to surgical gowns, nursing gowns, bedsheets, and other various linen supplies in hospitals and other facilities. Even if the antibacterial antifungal fiber structure of the present disclosure is repeatedly subjected to an industrial laundry process, its excellent antibacterial and antifungal properties can be maintained.

In particular, where the antibacterial antifungal agent (A) is present in an amount of 200 to 20,000 mg/kg based on the weight of the overall antibacterial antifungal fiber structure, and the antibacterial antifungal agent fixation aid (B) is present in an amount of 1 to 500 mg/kg based on the weight of the overall antibacterial antifungal fiber structure in the present disclosure, the antibacterial antifungal fiber structure is advantageous with excellent antibacterial and antifungal properties and washing durability.

In particular, where the antibacterial antifungal agent (A) is the pyridine metal complex in the present disclosure, the pyridine metal complex has an organic value/inorganic value ratio close to that of the polyester fibers. Therefore, the pyridine metal complex can be advantageously easily fixed in the polyester fibers.

In particular, where the first group (b1) of the antibacterial antifungal agent fixation aid (B) includes at least one selected from the two types of surfactants represented by the above formulae (1) and (2) in the present disclosure, or where the third group (b3) of the antibacterial antifungal agent fixation aid (B) includes at least one selected from the six types of aromatic compounds and urea compounds represented by the above formulae (3) to (8) in the present disclosure, the fixation amount of the antibacterial antifungal agent (A) can be advantageously increased.

In particular, where the antibacterial antifungal agent fixation aid (B) includes at least two compounds selected from any of the first group (b1), the second group (b2), and the third group (b3) in the present disclosure, or where the antibacterial antifungal agent fixation aid (B) includes at least one compound selected from the first group (b1) and at least one compound selected from the second group (b2) in the present disclosure, the fixation amount of the antibacterial antifungal agent (A) can be advantageously increased.

In particular, where the antibacterial antifungal agent fixation aid (B) includes at least one compound selected from the first group (b1) and at least one compound selected from the third group (b3) in the present disclosure, or where the antibacterial antifungal agent fixation aid (B) includes at least one compound selected from the second group (b2) and at least one compound selected from the third group (b3) in the present disclosure, the fixation amount of the antibacterial antifungal agent (A) can be advantageously increased.

In particular, where the antibacterial antifungal agent fixation aid (B) includes at least one compound selected from the first group (b1), at least one compound selected from the second group (b2), and at least one compound selected from the third group (b3) in the present disclosure, the fixation amount of the antibacterial antifungal agent (A) can be advantageously increased.

### BRIEF DESCRIPTION OF DRAWINGS

FIG. 1 is a schematic explanatory diagram showing an exemplary method for producing an antibacterial antifungal fiber structure according to the present disclosure.

FIGS. 2A and 2B are graphs for describing the problems to be solved by the present disclosure, particularly, FIG. 2A showing a relationship between the treatment temperature for treatment of polyester fibers and the ZPT fixation ratio, and FIG. 2B showing relationships between the ZPT treatment concentration (the concentration of ZPT adhering to the fibers) and the amount of ZPT actually fixed in the fibers when the treatment was performed at temperatures of 150° C. and 180° C.

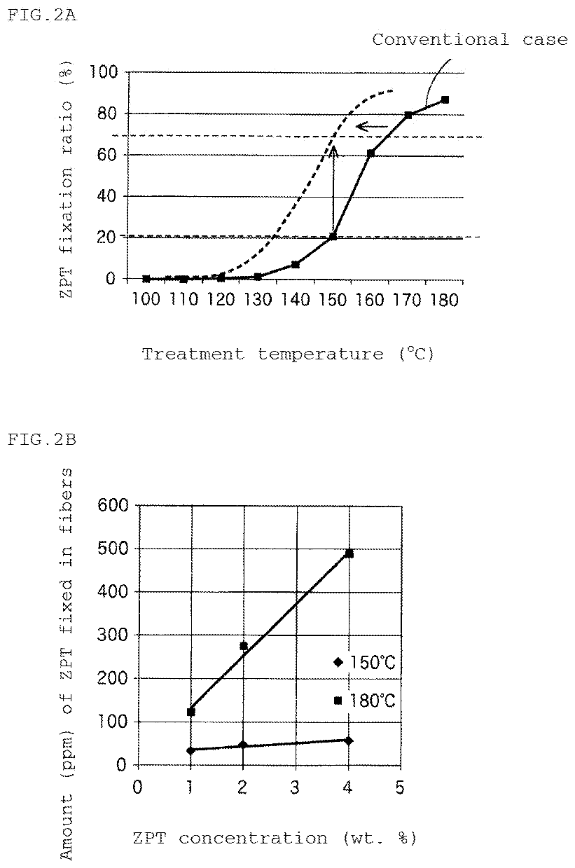

### DESCRIPTION OF EMBODIMENTS

Next, embodiments of the present disclosure will be described in detail. It should be understood that the disclosure be not limited to these embodiments.

The antibacterial antifungal fiber structure according to the present disclosure (hereinafter sometimes referred to simply as “fiber structure”) comprises a polyester mixed fiber structure, and an antibacterial antifungal agent (A) and an antibacterial antifungal agent fixation aid (B) contained in the polyester mixed fiber structure.

As described above, the term “polyester mixed fiber structure” means a fiber structure including polyester fibers and some other fibers in combination.

Exemplary polyesters for the polyester fibers include polyethylene terephthalates, polyethylene naphthalates, polytrimethylene terephthalates, and polybutylene terephthalates. These polyesters are widely used for various fiber structures because of their excellent heat resistance and chemical resistance, and high strength.

The thickness of the polyester fibers is not particularly limited, but the polyester fibers preferably have an average single fiber fineness of 0.1 to 100 dtex, particularly preferably 0.5 to 50 dtex, where the polyester fibers are subjected to an antibacterial antifungal agent treatment.

The other fibers are not particularly limited, but may be any of various fibers other than the polyester fibers. Examples of such fibers include: synthetic fibers such as of polyurethanes, polyamides, acryls, polyethylenes, and polypropylenes; semisynthetic fibers such as of cellulose and acetate; and natural fibers such as of silk, cotton, wool and hemp, which generally have a lower heat resistance and cannot be subjected to the high-temperature treatment. The polyester fibers are preferably used in combination with any of these fibers to provide the advantageous effects of the present disclosure. Particularly, the polyester fibers are preferably used in combination with the polyurethane fibers, the polyamide fibers or the cotton fibers. The fineness of the other fibers is not particularly limited, but the other fibers typically have an average single fiber fineness of 0.1 to 1,000 dtex, particularly preferably 1 to 500 dtex.

The polyester mixed fiber structure including the polyester fibers and the other fibers in combination may be a woven fabric or a knit fabric including a yarn of the polyester fibers and a yarn of the other fibers in combination, a nonwoven fabric including the polyester fibers and the other fibers in combination, a blended yarn produced by blending the polyester fibers and the other fibers, a woven or knit fabric produced by using the blended yarn, a composite yarn produced by composite-spinning the polyester and some other fiber material, or a woven or knit fabric produced by using the composite yarn.

In the present disclosure, as described above, the fiber structure may be in any of various forms such as yarn, knit fabric, woven fabric, and nonwoven fabric. Specific examples of products of the fiber structure include various clothing articles, socks, tights, sportswear, outdoor products, bedclothes, carpets, curtains, indoor cloths, and sanitary articles such as bandages, gauzes, and facemasks. In particular, the fiber structure of the present disclosure has washing-durable antibacterial and antifungal properties and, therefore, is advantageously used for linen supplies (surgical gowns, nursing gowns, nightwear, bedsheets, and the like) which are repeatedly subjected to an industrial laundry process for repeated use in medical facilities and care facilities.

In the present disclosure, a pyridine antibacterial antifungal agent which is excellent in antibacterial and antifungal properties and highly safe for human bodies is used as the antibacterial antifungal agent (A). A pyridine metal complex represented by the following formula (9), for example, is preferably used as the pyridine antibacterial antifungal agent. That is, as described in PTL 1, the pyridine metal complex has an organic value/inorganic value ratio close to that of the polyester fibers and, therefore, is advantageous in that the pyridine metal complex can be easily fixed in the polyester fibers.

In the following formula (9), M is a metal, and specific examples of the pyridine metal complex include bis(2-pyridylthio)copper-1,1′-dioxide containing Cu as M (hereinafter referred to as “copper pyrithione”), bis(2-pyridylthio)zinc-1,1′-dioxide containing Zn as M (hereinafter referred to as “zinc pyrithione”), and bis(2-pyridylthio)iron-1,1′-dioxide containing Fe as M (hereinafter referred to as “iron pyrithione”). However, iron pyrithione is colored purple in a solution and, therefore, is preferably used for applications in which the coloration causes no problem.

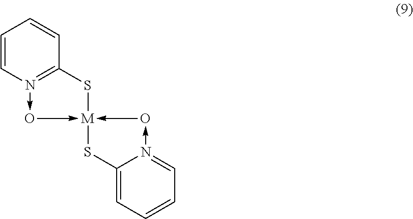

The pyridine metal complex is substantially insoluble in water and an organic solvent. In addition, the pyridine metal complex has a very high specific gravity and, therefore, preferably has an average particle diameter of 0.1 to 0.7 μm, particularly preferably 0.3 to 0.5 μm, so as to be stably suspended during an antibacterial antifungal treatment. The pyridine metal complex is preferably in a pulverized form such that pyridine metal complex particles having a particle diameter of not less than 2 μm are present in a proportion of not greater than 5 wt. %, preferably not greater than 3 wt. %, more preferably not greater than 1 wt. %, based on the weight of the overall pyridine metal complex particles.

The average particle diameter of the pyridine metal complex may be determined as a 50% cumulative volume median diameter in a particle size distribution measured in conformity with JIS R1629 by means of a laser diffraction particle diameter distribution measurement apparatus.

Usable as the antibacterial antifungal agent fixation aid (B) in combination with the antibacterial antifungal agent (A) is at least one compound selected from:

(b1) a first group comprising a surfactant;
(b2) a second group comprising an organic solvent; and
(b3) a third group comprising an aromatic compound and a urea compound.

A nonionic surfactant and/or an anionic surfactant is typically used as the surfactant of the first group (b1). Examples of the nonionic surfactant include ester nonionic surfactants such as glycerin laurate and sorbitan fatty acid esters, ether nonionic surfactants such as polyoxyalkylene alkyl ethers and polyoxyalkylene alkyl phenyl ethers, ester ether nonionic surfactants such as polyoxyalkylene sorbitan fatty acid esters, alkanolamide nonionic surfactants such as stearic acid diethanolamide, alkyl glycoside nonionic surfactants such as octyl glucoside, and higher alcohol nonionic surfactants such as cetanol. Examples of the anionic surfactant include alkylbenzene sulfonates and other anionic surfactants. These may be used alone or in combination.

Of these surfactants, the nonionic surfactant is preferred because it is less foamable and allows for easy balance between a hydrophilic group and a hydrophobic group. Particularly, a nonionic surfactant highly affinitive for the pyridine antibacterial antifungal agent is preferred.

These surfactants are each capable of changing the surface energy of the fibers to increase the affinity of the pyridine antibacterial antifungal agent for the fiber surfaces, thereby selectively increasing the existence probability of the pyridine antibacterial antifungal agent (A) on around the fiber surfaces. Therefore, the surfactant infiltrates together with the antibacterial antifungal agent (A) into the amorphous portions of the fibers. Thus, the surfactant has an effect for assisting the infiltration of the antibacterial antifungal agent (A).

Of the aforementioned surfactants, the ether nonionic surfactants are preferred from the viewpoint of the effect for fixing the antibacterial antifungal agent (A) in the fibers. Particularly, it is most preferred to use at least one selected from two types of nonionic surfactants represented by the following formulae (1) and (2):

R¹—O—(R²O)ₙ—H (1)

wherein R¹ is C₈ to C₁₈ alkyl group, and R² is alkylene group; and

ϕ-O—(R³O)ₙ—H (2)

wherein ϕ is polycyclic phenyl group, and R³ is alkylene group.

The number of carbons of the alkyl group and the repetition number n of the oxyalkylene in each of the compounds of the formulae (1) and (2) are properly adjusted so that the HLB value of the nonionic surfactant can be set to a desired level. The HLB value of the nonionic surfactant is preferably set to 6 to 19, particularly preferably 8 to 18, from the viewpoint of the effect for fixing the antibacterial antifungal agent (A) in the fibers.

The organic solvent of the second group (b2) is preferably less volatile. Specifically, a less volatile organic solvent having a boiling point of not lower than 100° C. is preferred. A less volatile organic solvent having a boiling point of not lower than 150° C. is more preferred. If the boiling point of the organic solvent is lower than 100° C., the organic solvent may evaporate during the heat treatment, failing to infiltrate into the fibers. In contrast, the organic solvent having a boiling point of not lower than 150° C. does not evaporate during the heat treatment, but effectively sufficiently infiltrates into the fibers. Examples of the organic solvent include dimethyl sulfoxide (DMSO), tetrahydrofuran (THF), N-methyl-2-pyrrolidone (NMP), and 1,3-butylene glycol, which may be used alone or in combination. These organic solvents have an effect for promoting the infiltration of the antibacterial antifungal agent (A), and the mobility of the other compounds to be used in combination with the organic solvent as the antibacterial antifungal agent fixation aid (B).

On the other hand, examples of the aromatic compound of the third group (b3) include monosubstituted aromatic monocyclic compounds such as toluene and benzoic acid, disubstituted aromatic monocyclic compounds such as xylene, salicylic acid, and guaiacol (methoxyphenol), aromatic polycyclic compounds such as phenyl salicylate and o-phenylphenol, and condensed cyclic compounds such as naphthalene and anthracene, which may be used alone or in combination.

These aromatic compounds infiltrate into the polyester fibers to thereby provide an effect for enhancing the molecular chain motion in the amorphous portions of the polyester fibers, and expend the interstices of the amorphous portions of the polyester fibers to thereby provide an effect for increasing the infiltration rate of the antibacterial agent and the like.

Of these aromatic compounds, at least one selected from four types of aromatic compounds represented by the following formulae (3) to (6) is most preferably used to provide the effects.

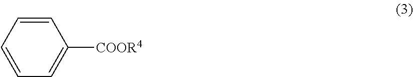

wherein R⁴ is alkyl group.

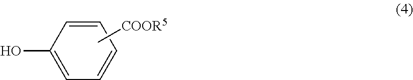

wherein R⁵ is alkyl group.

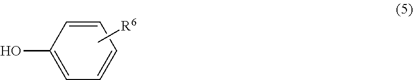

wherein R⁶ is alkyl group.

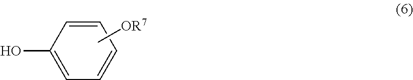

wherein R⁷ is alkyl group.

If the number of carbons of the substituent introduced into the aromatic ring in each of the compounds of the formulae (3) to (6) is excessively small, the compounds are liable to evaporate before infiltrating into the polyester fibers. If the number of carbons of the substituent is excessively great, the compounds will not infiltrate into the polyester fibers. The number of carbons of the substituent is typically 1 to 10, preferably 1 to 5.

Examples of the urea compound of the third group (b3) include urea, ethylene urea (2-imidazolidinone), dimethylolethylene urea, dimethylhydroxyethylene urea, and dibutylurea, which may be used alone or in combination.

Like the aromatic compounds described above, the urea compounds infiltrate into the polyester fibers to thereby provide an effect for enhancing the molecular chain motion in the amorphous portions, and expend the interstices of the amorphous portions to thereby provide an effect for increasing the infiltration rate of the antibacterial agent and the like.

Of these urea compounds, at least one selected from two types of urea compounds represented by the following formulae (7) and (8) is most preferably used to provide the effects.

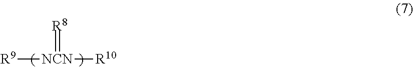

wherein R⁸ is oxygen atom or sulfur atom, and R⁹ and R¹⁰ are each alkyl group or hydrogen atom.

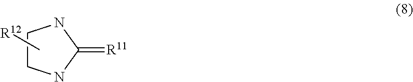

wherein R¹¹ is oxygen atom or sulfur atom, and R¹² is alkyl group or hydrogen atom.

If the number of carbons of the alkyl group substituent in each of the compounds of the formulae (7) and (8) is excessively great, the compounds will not infiltrate into the polyester fibers. Therefore, the number of carbons of the alkyl group substituent is typically 0 to 10, preferably 0 to 5.

The antibacterial antifungal agent fixation aid (B) may be at least one compound or a single compound selected from the surfactants of the first group (b1), the organic solvents of the second group (b2), and the aromatic compounds and the urea compounds of the third group (b3). It is more preferred to use at least two compounds selected from the three groups in combination as the antibacterial antifungal agent fixation aid (B) in order to increase the infiltration fixation amount of the antibacterial antifungal agent (A).

It is more preferred to use at least three compounds selected from the three groups described above in combination as the antibacterial antifungal agent fixation aid (B) in order to further increase the infiltration fixation amount of the antibacterial antifungal agent (A).

Further, at least one compound selected from the surfactants of the first group (b1) and at least one compound selected from the organic solvents of the second group (b2) are more preferably used in combination as the antibacterial antifungal agent fixation aid (B) to provide the effects.

Further, at least one compound selected from the surfactants of the first group (b1) and at least one compound selected from the aromatic compounds and the urea compound of the third group (b3) are more preferably used in combination as the antibacterial antifungal agent fixation aid (B) to provide the effects.

Further, at least one compound selected from the organic solvents of the second group (b2) and at least one compound selected from the aromatic compounds and the urea compounds of the third group (b3) are more preferably used in combination as the antibacterial antifungal agent fixation aid (B) to provide the effects.

In particular, at least one compound selected from the surfactants of the first group (b1), at least one compound selected from the organic solvents of the second group (b2), and at least one compound selected from the aromatic compounds and the urea compounds of the third group (b3) are preferably used in combination as the antibacterial antifungal agent fixation aid (B) to provide particularly excellent effects.

The antibacterial antifungal fiber product of the present disclosure can be produced, for example, in the following manner by using the antibacterial antifungal agent (A) and the antibacterial antifungal agent fixation aid (B). First, the antibacterial antifungal agent (A) is pulverized and stirred in the presence of the antibacterial antifungal agent fixation aid (B) and water by pulverization means such as ball mill or hammer mill, whereby a dispersion, e.g., an aqueous suspension or an aqueous emulsion, containing both the antibacterial antifungal agent (A) and the antibacterial antifungal agent fixation aid (B) is prepared. Alternatively, two types of liquids, i.e., an aqueous suspension of the antibacterial antifungal agent (A) prepared in the aforementioned manner and an aqueous emulsion or an aqueous solution of the antibacterial antifungal agent fixation aid (B), may be prepared, which are mixed together when the treatment is performed. These liquids are referred to as “treatment preparation liquids” for convenience.

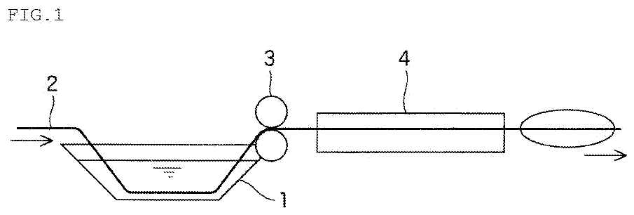

For example, as shown in FIG. 1, water is put in a treatment vessel 1 in which a polyester mixed fiber structure 2 is to be immersed, and then the treatment preparation liquids (one or two liquids) are fed into the water to prepare a treatment liquid containing the antibacterial antifungal agent (A) and the antibacterial antifungal agent fixation aid (B) at predetermined concentrations. The polyester mixed fiber structure 2 is immersed in the treatment liquid in the treatment vessel 1, and passed through squeeze rolls 3 to be pulled up and lightly squeezed, and then introduced into a heating device 4. The polyester mixed fiber structure 2 is moved in the heating device 4 to be thereby subjected to a heat treatment (so-called pad dry process) at a predetermined temperature (e.g., 150° C.) for a predetermined period (e.g., 2 minutes), whereby the antibacterial antifungal agent (A) and the antibacterial antifungal agent fixation aid (B) are infiltration-fixed in all the fibers including the polyester fibers. Thus, the antibacterial antifungal fiber structure of interest is produced.

Of course, the method for producing the antibacterial antifungal fiber structure of the present disclosure is not limited to this exemplary method, but any other method may be employed. However, there is no need to employ a high-temperature treatment, because a sufficient amount of the antibacterial antifungal agent (A) can be fixed in all the fibers including the polyester fibers by the action of the antibacterial antifungal agent fixation aid (B) even at a low heating temperature (e.g., 150° C.) in the treatment according to the feature of the present disclosure.

This is because the antibacterial antifungal agent fixation aid (B) improves the affinity of the polyester fiber surfaces for the antibacterial antifungal agent (A) or infiltrates into the polyester fibers to enhance the molecular chain motion in the amorphous portions of the polyester fibers and expand the interstices of the amorphous portions, thereby promoting the infiltration of the antibacterial antifungal agent (A). Thus, the antibacterial antifungal agent (A) can be infiltration-fixed in the fibers in a short period of time. In the present disclosure, the antibacterial antifungal agent (A) is firmly infiltration-fixed in the fibers and, therefore, the antibacterial antifungal agent (A) and the antibacterial antifungal agent fixation aid (B) are less liable to be detached from the antibacterial antifungal fiber structure even if the fiber structure is repeatedly subjected to the washing. Thus, the antibacterial antifungal fiber structure advantageously exhibits excellent antibacterial and antifungal properties for a longer period of time. However, the antibacterial antifungal agent fixation aid (B), which is highly permeable to the polyester fibers, is more liable to be detached from the fiber structure by the washing than the antibacterial antifungal agent (A).

The amount of the antibacterial antifungal agent (A) in the antibacterial antifungal fiber structure of the present disclosure depends upon the form and the treatment temperature of the fiber structure. To ensure practical antibacterial antifungal performance, the fiber structure typically contains the antibacterial antifungal agent (A) in an amount of 200 to 20,000 mg/kg, preferably 200 to 600 mg/kg, based on the weight of the overall fiber structure before use after the production.

The amount of the antibacterial antifungal agent fixation aid (B) used together with the antibacterial antifungal agent (A) in the antibacterial antifungal fiber structure also depends upon the form and the treatment temperature of the fiber structure. The fiber structure typically contains the antibacterial antifungal agent fixation aid (B) in an amount of 1 to 500 mg/kg, based on the weight of the overall fiber structure before use after the production. Particularly, a compound selected from the first group (b1) as the antibacterial antifungal agent fixation aid (B) is preferably present in an amount of 1 to 100 mg/kg, more preferably 1 to 50 mg/kg, and a compound selected from the second group (b2) and the third group (b3) as the antibacterial antifungal agent fixation aid (B) is preferably present in an amount of 10 to 500 mg/kg, more preferably 10 to 100 mg/kg.

The amounts of the compounds of the first group (b1), the second group (b2), and the third group (b3) to be contained as the antibacterial antifungal agent fixation aid (B) are different. The compounds of the first group (b1) each mainly work outside the polyester fibers to introduce the antibacterial antifungal agent (A) into the polyester fibers and, therefore, are active at a relatively low concentration in the polyester fibers. In contrast, the compounds of the second group (b2) and the third group (b3) each infiltrate into the polyester fibers to contribute to the mobility and the expansion in the polyester fibers and, therefore, are easily fixed at a relatively high concentration in the polyester fibers.

The treatment preparation liquids to be used for the preparation of the treatment liquid containing the antibacterial antifungal agent (A) and the antibacterial antifungal agent fixation aid (B) in the method for producing the antibacterial antifungal fiber structure of the present disclosure typically each have a pH of 4 to 10, preferably 5.5 to 8.5, more preferably 6 to 8, for stabilization thereof for a prolonged period and for improvement of the fixation ratio of the antibacterial antifungal agent (A) in the fibers. Where the treatment preparation liquid has a pH on an alkaline side of the aforementioned pH range, an acid such as acetic acid, hydrochloric acid or phosphoric acid may be added to the treatment preparation liquid. Where the treatment preparation liquid has a pH on an acidic side of the aforementioned pH range, an alkali such as sodium carbonate or sodium hydroxide may be added to the treatment preparation liquid.

As required, an additive may be added to the treatment preparation liquids or the treatment liquid. Examples of the additive include organic solvent (an organic solvent different from that used as the antibacterial antifungal agent fixation aid (B), e.g., a highly volatile organic solvent having a boiling point of lower than 100° C.), tackifier, antifreezing agent, antifouling agent, softener, flame retardant, fire retardant, insecticide, antistatic agent, and UV screening agent.

Examples of the organic solvent (highly volatile organic solvent) include alcohols having a boiling point of lower than 100° C. These are used to solubilize a less water-soluble component, but do not remain in the final product because of their high volatility.

Examples of the tackifier include sodium polyacrylate, carboxymethyl cellulose, polyvinyl alcohol, and acetic acid starch. Examples of the antifreezing agent include glycerin and potassium acetate.

As described above, the treatment temperature at which the antibacterial antifungal agent fixation aid (B) especially exhibits its effects in the present disclosure is relatively low, typically not higher than 160° C., preferably 120° C. to 150° C. The treatment period is preferably not shorter than 10 seconds and shorter than 10 minutes, particularly preferably 30 seconds to 5 minutes.

If the treatment temperature is lower than 120° C., the infiltration fixation amount of the antibacterial antifungal agent (A) will be excessively small and, therefore, the antibacterial and antifungal properties will be insufficient. If the treatment temperature is higher than 160° C., the hardening and the melting of the polyester mixed fibers, and other inconveniences are liable to occur. If the treatment period is shorter than 10 seconds, the antibacterial antifungal agent (A) will not sufficiently infiltrate into the polyester mixed fibers because of insufficient heat transfer to the polyester mixed fibers. A treatment period of 10 minutes or longer is not preferred, because less heat-resistant fibers are more liable to be hardened, and the treatment efficiency is liable to decrease.

### EXAMPLES

Next, the embodiments of the present disclosure will be described by way of examples in conjunction with comparative examples. However, it should be understood that the embodiments of the present disclosure be not limited to these examples.

First, zinc pyrithione was prepared as the antibacterial antifungal agent (A), and a treatment preparation liquid X (aqueous suspension) containing only the antibacterial antifungal agent (A) was prepared. Further, treatment preparation liquids Y (aqueous solution or emulsion) containing only the antibacterial antifungal agent fixation aid (B) were prepared as shown below. Then, treatment liquids were prepared by properly diluting the treatment preparation liquid X and the treatment preparation liquids Y with water, and were each used for infiltration and fixation of zinc pyrithione in fibers.

<Preparation of Treatment Preparation Liquid X>

First, 20 parts by weight of zinc pyrithione (available in a powdery form from Lonza Japan Co., Ltd., having a particle diameter of about 0.025 mm, and sometimes abbreviated to “ZPT”), 3 parts by weight of polyoxyethylene hydrogenated castor oil (dispersant), 0.5 parts by weight of sodium polyacrylate (tackifier), 2 parts by weight of glycerin (antifreezing agent), and 74.5 parts by weight of water were prepared, and fed into a ball mill (using glass balls), and then a milling operation was performed. At the start of the milling operation, the pH of the liquid was 6.5. After the milling operation was performed for 12 hours, the pH of the resulting liquid was 10.5. At this time, acetic acid was added to the liquid, so that the pH was adjusted to 8.0. Thus, the treatment preparation liquid X was prepared. In the treatment preparation liquid X thus prepared, the resulting zinc pyrithione particles had an average particle diameter of 0.4 μm, and the percentage of zinc pyrithione particles having particle diameters of not smaller than 2 μm was 0.5 wt. % based on the overall zinc pyrithione particles. In the treatment preparation liquid X, the zinc pyrithione particles were present at a concentration of 20 wt. %, and were homogeneously dispersed. After a part of the treatment preparation liquid X was transferred into a 1-liter container and allowed to stand for 24 hours, the zinc pyrithione particles were not significantly separated from the treatment preparation liquid X.

<Preparation of Treatment Preparation Liquids Y>

The treatment preparation liquids Y to be diluted with water were each prepared as containing an antibacterial antifungal agent fixation aid (B) having a formulation as shown below in Tables 1 to 7.

Treatment liquids having formulations shown below in Tables 1 to 7 were prepared by using the treatment preparation liquids X and Y described above. Components contained in the treatment liquids, and fibers to be treated will hereinafter be described in detail.

<Antibacterial Antifungal Agent Fixation Aid (B)>

<First Group (b1)>
Surfactant 1: polyoxyethylene alkyl ether (C12-13 HLB 14.0) available from Nippon Nyukazai Co., Ltd.
Surfactant 2: polyoxyethylene alkyl ether (C18 HLB 17.4) available from Nippon Nyukazai Co., Ltd.
Surfactant 3: polyoxyethylene alkyl ether (C8 HLB 7.9) available from Nippon Nyukazai Co., Ltd.
Surfactant 4: polyoxyethylene polycyclic phenyl ether (HLB 13.6) available from Nippon Nyukazai Co., Ltd.
Surfactant 5: polyoxyalkylene alkyl ether (HLB 13.7) available from Nippon Nyukazai Co., Ltd.
Surfactant 6: polyoxyalkylene polycyclic phenyl ether (HLB 13.3) available from Nippon Nyukazai Co., Ltd.
<Second Group (b2)>
Organic solvent 1: 1-methyl-2-pyrrolidone (available from Wako Pure Chemical Industries, Ltd.)
Organic solvent 2: 1,3-butylene glycol (available from Nippon Nyukazai Co., Ltd.)
<Third Group (b3)>
Aromatic compound 1: benzoic acid (available from Wako Pure Chemical Industries, Ltd.)
Aromatic compound 2: sodium benzoate (available from Wako Pure Chemical Industries, Ltd.)
Aromatic compound 3: guaiacol (available from Wako Pure Chemical Industries, Ltd.)
Aromatic compound 4: o-phenylphenol (available from Wako Pure Chemical Industries, Ltd.)
Urea compound 1: urea (available from Wako Pure Chemical Industries, Ltd.)
Urea compound 2: ethylene urea (available from Wako Pure Chemical Industries, Ltd.)

<Treated Fibers>

Fibers 1: polyester mixed fibers (polyester/polyurethane=97/3)
Fibers 2: polyester mixed fibers (polyester/cotton=65/35)
Fibers 3: polyester mixed fibers (polyester/polyamide=85/15)

Products of Examples and Comparative Examples produced through a treatment were analyzed and evaluated for the following evaluation items in the following manner.

<Determination of Amount of Antibacterial Antifungal Agent (A)>

A sample was prepared by asking 0.1 g of each of the treated products (Examples and Comparative Examples) and extracting zinc from the product with the use of hydrochloric acid, and the sample was analyzed by atomic absorption method to determine the amount of zinc attributable to zinc pyrithione contained in the fibers. The amount of zinc pyrithione was calculated based on the amount of zinc thus determined.

<Determination of Amount of Antibacterial Antifungal Agent Fixation Aid (B)>

Where the antibacterial antifungal agent fixation aid (B) is a surfactant, a sample was prepared by putting 30 g of each of the treated products in 150 ml of water and extracting the surfactant from the product at 130° C. for 30 minutes, and the sample was analyzed by LC-MS/MS analysis to determine the amount of the surfactant in the fibers.

Where the antibacterial antifungal agent fixation aid (B) is an organic solvent, an aromatic compound or a urea compound, a sample was prepared by putting 1 g of each of the treated products in 10 g of tetrachloroethane and extracting the target compound from the product at 80° C. for 3 hours, and the sample was analyzed by a gas chromatography method to determine the amount of the target compound in the fibers.

<Evaluation for Antibacterial Properties 1 and 2>

In conformity with JIS L1902, evaluation was performed for antibacterial properties 1 and 2 by using Staphylococcus aureus and Klebsiella pneumoniae, respectively, as test bacterial species. More specifically, a standard fabric (cotton fabric having no antibacterial activity) and a treated fiber fabric were each inoculated with living bacteria of the test bacterial species described above, which were incubated at 37° C. for 18 to 24 hours. Then, the numbers of living bacteria on the standard fabric and on the treated fiber fabric were measured. The antibacterial activity value was calculated based on the measured living bacteria numbers from the following expressions:

Antibacterial activity value=(Log Ct−Log Co)−(Log Tt−Log To)

Growth value of standard fabric=(Log Ct−Log Co)

Log Co: The common logarithm of the arithmetic average of the living bacteria numbers of three samples of the standard fabric immediately after the inoculation of the test bacteria on the standard fabric samples.
Log Ct: The common logarithm of the arithmetic average of the living bacteria numbers of the three samples of the standard fabric after the 18-hour bacteria incubation on the standard fabric samples.
Log To: The common logarithm of the arithmetic average of the living bacteria numbers of three samples of the treated fiber fabric immediately after the inoculation of the test bacteria on the treated fiber fabric samples.
Log Tt: The common logarithm of the arithmetic average of the living bacteria numbers of the three samples of the treated fiber fabric after the 18-hour bacteria incubation on the treated fiber fabric samples.

Where the antibacterial activity value was not smaller than the growth value of the standard fabric, the treated fiber fabric was rated as “significantly effective (o).” Where the antibacterial activity value was smaller than the growth value of the standard fabric and not smaller than 2.2, the treated fiber fabric was rated as “effective (Δ).” Where the antibacterial activity value was smaller than 2.2, the treated fiber fabric was rated as “ineffective (x).” This evaluation method is based on “The Certification Standards of SEK mark textile products” specified by Japan Textile Evaluation Technology Council. Further, the treated fabric (washed treated fabric) was evaluated for the antibacterial properties 1 and 2 in the aforementioned manner after being washed by a washing method to be described later.

<Evaluation for Antifungal Property>

In conformity with JIS L1921, evaluation was performed by using Trichophyton mentagrophytes as test fungus species and measuring the amount of ATP contained in fungus cells. More specifically, a treated product was inoculated with a liquid medium in which spores of the test fungus species were suspended, and then incubated at 25° C. for 42 hours. After the incubation, the ATP amount was measured, and an antifungal activity value was determined based on the ATP amount thus measured and a test value (ATP amount) determined for an untreated cotton fiber product. Where the antifungal activity value was reduced by not less than 3 which means that the ATP amount was 1/1,000 of the growth value of the untreated cotton fiber product, the treated product was rated as “significantly effective (o).” Where the antifungal activity value was reduced by less than 3 and not less than 2 which means that the ATP amount was 1/100 of the growth value of the untreated cotton fiber product, the treated product was rated as “effective (Δ).” Where the antifungal activity value was reduced by less than 2, the treated product was rated as “ineffective (x).” Further, the treated product (washed treated product) was evaluated for the antifungal property in the aforementioned manner after being washed in the same manner as for the evaluation for the antibacterial properties 1 and 2.

<Washing Method>

A washing operation was performed 50 times in conformity with “Washing Method for SEK Mark Textile Products (High-Temperature Accelerated Washings)” specified by Japan Textile Evaluation Technology Council.

<Fixation Amount Increase Ratio of Antibacterial Antifungal Agent (A)>

The increase ratio (%) of the antibacterial antifungal agent (A) fixed in the fibers with the additional use of the antibacterial antifungal agent fixation aid (B) (referred to simply as “increase ratio” in Tables) was calculated by the following method:

Increase ratio (%)=ZPT₁/ZPT₂×100

wherein ZPT₁ is the amount of ZPT fixed in the fibers by the treatment with the additional use of the antibacterial antifungal agent fixation aid (B), and ZPT₂ is the amount of ZPT fixed in the fibers by the treatment without the additional use of the antibacterial antifungal agent fixation aid (B).

### Example 1

A treatment liquid was prepared by blending 0.2 wt. % of zinc pyrithione, 1 wt. % of Surfactant 1, 1 wt. % of Surfactant 2, 1 wt. % of Organic solvent 2, and 1 wt. % of Aromatic compound 1, and a fabric of Fibers 1 was immersed in the treatment liquid. The resulting fabric was squeezed to a treatment liquid percentage of 50% based on the weight of the fibers by means of a roller squeezer, and then heat-treated at 150° C. for 2 minutes with the use of a pin tenter (PT-2A available from Tsujii Senki Kogyo Co., hereinafter the same). Further, an overflow washing operation was performed for 5 minutes by a washing machine to wash away unnecessary components from the surfaces of the fibers with water, and then the resulting fabric was air-dried overnight. Thus, a treated product of interest was produced.

### Comparative Example 1

A treatment liquid containing 0.2 wt. % of zinc pyrithione was prepared, and a fabric of Fibers 1 was immersed in the treatment liquid. The resulting fabric was squeezed to a treatment liquid percentage of 50% based on the weight of the fibers by means of the roller squeezer, and then heat-treated at 150° C. for 2 minutes with the use of the pin tenter. Further, the overflow washing operation was performed for 5 minutes by the washing machine to wash away unnecessary components from the surfaces of the fibers with water, and then the resulting fabric was air-dried overnight. Thus, a treated product of interest was produced.

The products of Example 1 and Comparative Example 1 were analyzed and evaluated in the aforementioned manner. The results of the analysis and the evaluation are shown below together with the formulations of the treatment liquids in Table 1.

TABLE 1

| | | | Comparative | Exam- |
|---|---|---|---|---|
| | | | Example 1 | ple 1 |
| Type of fibers | | | Fibers 1 | Fibers 1 |
| Formulation of treatment liquid (wt.%) | | | | |
| A | Zinc pyrithione | | 0.2 | 0.2 |
| B | b1 | Surfactant 1 | — | 1 |
| | | Surfactant 2 | — | 1 |
| | b2 | Organic solvent 2 | — | 1 |
| | b3 | Aromatic compound 1 | — | 1 |

| Water | 99.8 | 95.8 |
|---|---|---|
| Results of analysis (mg/kg) | | |
| Zinc pyrithione | 183 | 300 |
| Surfactant 1 | — | 10 |
| Surfactant 2 | — | 2 |
| Aromatic compound 1 | — | 75 |
| Organic solvent 2 | — | 78 |
| Results of evaluation | | |
| Antibacterial property 1 | ×/× | ○/○ |
| (before washing/after washing) | | |
| Antibacterial property 2 | ×/× | Δ/Δ |
| (before washing/after washing) | | |
| Antifungal property | ×/× | Δ/Δ |
| (before washing/after washing) | | |
| Increase ratio (%) | — | 160 |

The above results indicate that the product of Example 1 containing the antibacterial antifungal agent (A) and the antibacterial antifungal agent fixation aid (B) (b1 to b3) infiltration-fixed in the fibers thereof had washing-durable antibacterial and antifungal properties. In the product of Comparative Example 1 containing no antibacterial antifungal agent fixation aid (B), in contrast, the fixation amount of the antibacterial antifungal agent (A) was smaller.

### Comparative Examples 2 and 3

Treated products of interest were produced in substantially the same manner as in Comparative Example 1, except that the formulations of the treatment liquids and the types of the fibers were changed as shown in Table 2. The products of Comparative Examples 2 and 3 were analyzed and evaluated in the aforementioned manner. The results of the analysis and the evaluation are shown below together with the formulations of the treatment liquids in Table 2.

TABLE 2

| | | Comparative | |
|---|---|---|---|
| | | Example | |
| | | 2 | 3 |
| Type of fibers | | Fibers 2 | Fibers 3 |
| Formulation of treatment liquid (wt.%) | | | |
| A | Zinc pyrithione | 0.2 | 0.2 |
| B | Antibacterial antifungal | — | — |
| | agent fixation aid | | |

| Water | 99.8 | 99.8 |
|---|---|---|
| Results of analysis | | |
| Zinc pyrithione (mg/kg) | 150 | 159 |
| Results of evaluation | | |
| Antibacterial property 1 | ×/× | ×/× |
| (before washing/after washing) | | |
| Antibacterial property 2 | ×/× | ×/× |
| (before washing/after washing) | | |
| Antifungal property | ×/× | ×/× |
| (before washing/after washing) | | |
| Increase ratio (%) | — | — |

The above results indicate that, in Comparative Examples 2 and 3 in which the different types of fibers were used, it was impossible to effectively fix zinc pyrithione in the fibers without the use of the antibacterial antifungal agent fixation aid (B).

### Examples 2 to 7

Treated products of interest were produced in substantially the same manner as in Example 1, except that the formulations of the treatment liquids were changed as shown in Table 3. The products of Examples 2 to 7 were analyzed and evaluated in the aforementioned manner. The results of the analysis and the evaluation are shown below together with the formulations of the treatment liquids in Table 3. Since a sufficient amount of zinc pyrithione (antibacterial antifungal agent (A)) was fixed in the fibers, it is obvious that the antibacterial antifungal agent fixation aid (B) was also fixed in a sufficient amount in the fibers. Therefore, data of the results of the analysis of the antibacterial antifungal agent fixation aid (B) is not shown in Table 3.

TABLE 3

| | Example | | | | | |
|---|---|---|---|---|---|---|
| | 2 | 3 | 4 | 5 | 6 | 7 |
| Type of fibers | Fibers 1 | Fibers 1 | Fibers 1 | Fibers 1 | Fibers 1 | Fibers 1 |

Formulation of treatment liquid (wt. %)

| A | Zinc Pyrithione | | 0.2 | 0.2 | 0.2 | 0.2 | 0.2 | 0.2 |
|---|---|---|---|---|---|---|---|---|
| B | b1 | Surfactant 1 | — | — | 1 | 3 | — | — |
| | | Surfactant 2 | — | — | — | — | 1 | — |
| | b2 | Organic solvent 2 | 1 | 3 | — | — | — | — |
| | b3 | Urea compound 1 | — | — | — | — | — | 2 |

| | | | | | | |
|---|---|---|---|---|---|---|
| Water | 98.8 | 96.8 | 98.8 | 96.8 | 98.8 | 98.8 |

Results of analysis

| | | | | | | |
|---|---|---|---|---|---|---|
| Zinc pyrithione (mg/kg) | 260 | 258 | 253 | 264 | 243 | 273 |

Results of evaluation

| | | | | | | |
|---|---|---|---|---|---|---|
| Antibacterial property 1 (before washing/after washing) | ∘/∘ | ∘/∘ | ∘/∘ | ∘/∘ | ∘/∘ | ∘/∘ |
| Antibacterial property 2 (before washing/after washing) | Δ/Δ | Δ/Δ | Δ/Δ | Δ/Δ | Δ/Δ | Δ/Δ |
| Antifungal property (before washing/after washing) | Δ/Δ | Δ/Δ | Δ/Δ | Δ/Δ | Δ/Δ | Δ/Δ |
| Increase ratio (%) | 142 | 141 | 138 | 144 | 133 | 149 |

The above results indicate that, in the products of Examples 2 to 7 each containing a single compound selected from the groups (b1) to (b3) as the antibacterial antifungal agent fixation aid (B), the infiltration fixation amounts of the antibacterial antifungal agent (A) were greater by about 30% to about 50% than in the product of Comparative Example 1 containing no antibacterial antifungal agent fixation aid (B).

### Examples 8 to 14

Treated products of interest were produced in substantially the same manner as in Example 1, except that the formulations of the treatment liquids were changed as shown in Tables 4 and 5. The products of Examples 8 to 14 were analyzed and evaluated in the aforementioned manner. The results of the analysis and the evaluation are shown below together with the formulations of the treatment liquids in Tables 4 and 5. As in Table 3, data of the results of the analysis of the antibacterial antifungal agent fixation aid (B) is not shown in Tables 4 and 5.

TABLE 4

| | Example | | | | |
|---|---|---|---|---|---|
| | 8 | 9 | 10 | 11 | 12 |
| Type of fibers | Fibers 1 | Fibers 1 | Fibers 1 | Fibers 1 | Fibers 1 |

Formulation of treatment liquid (wt. %)

| A | Zinc Pyrithione | | 0.2 | 0.2 | 0.2 | 0.2 | 0.2 |
|---|---|---|---|---|---|---|---|
| B | b1 | Surfactant 1 | 1 | — | 1 | 1 | 1 |
| | | Surfactant 2 | — | — | 1 | — | — |
| | | Surfactant 3 | — | — | — | — | — |
| | | Surfactant 4 | — | — | — | — | — |
| | | Surfactant 5 | — | 1 | — | 1 | — |
| | | Surfactant 6 | — | — | — | — | 1 |
| | b2 | Organic solvent 1 | 1 | 1 | 1 | — | — |
| | | Organic solvent 2 | — | — | — | 1 | 1 |

| | | | | | |
|---|---|---|---|---|---|
| Water | 97.8 | 97.8 | 96.8 | 96.8 | 96.8 |

Results of analysis

| | | | | | |
|---|---|---|---|---|---|
| Zinc pyrithione (mg/kg) | 295 | 290 | 342 | 358 | 340 |

Results of evaluation

| | | | | | |
|---|---|---|---|---|---|
| Antibacterial property 1 (before washing/after washing) | ∘/∘ | ∘/∘ | ∘/∘ | ∘/∘ | ∘/∘ |
| Antibacterial property 2 (before washing/after washing) | ∘/∘ | ∘/∘ | ∘/∘ | ∘/∘ | ∘/∘ |
| Antifungal property (before washing/after washing) | Δ/Δ | Δ/Δ | ∘/∘ | ∘/∘ | ∘/∘ |
| Increase ratio (%) | 161 | 158 | 187 | 196 | 186 |

TABLE 5

| | Example | |
|---|---|---|
| | 13 | 14 |
| Type of fibers | Fibers 1 | Fibers 1 |

Formulation of treatment liquid (wt.%)

| A | Zinc Pyrithione | | 0.2 | 0.2 |
|---|---|---|---|---|
| B | b1 | Surfactant 1 | 1 | 0.2 |
| | | Surfactant 2 | — | — |
| | | Surfactant 3 | — | — |
| | | Surfactant 4 | 1 | 0.2 |
| | | Surfactant 5 | — | — |
| | | Surfactant 6 | — | — |
| | b2 | Organic solvent 1 | 1 | 0.3 |
| | | Organic solvent 2 | 1 | 0.3 |

| | | |
|---|---|---|
| Water | 95.8 | 98.8 |

Results of analysis

| | | |
|---|---|---|
| Zinc pyrithione (mg/kg) | 360 | 302 |

Results of evaluation

| | | |
|---|---|---|
| Antibacterial property 1 | ○/○ | ○/○ |
| (before washing/after washing) | | |
| Antibacterial property 2 | ○/○ | ○/○ |
| (before washing/after washing) | | |
| Antifungal property | ○/○ | Δ/Δ |
| (before washing/after washing) | | |
| Increase ratio (%) | 197 | 165 |

The above results indicate that, in the products of Examples 8 and 9 each produced by using a single surfactant and a single organic solvent selected from the compounds of the group (b1) and the compounds of the group (b2) in combination as the antibacterial antifungal agent fixation aid (B), the infiltration fixation amounts of the antibacterial antifungal agent (A) were greater by about 60% than in the product of Comparative Example 1 containing no antibacterial antifungal agent fixation aid (B). In the products of Examples 10 to 12 each produced by using two surfactants and one organic solvent selected from the compounds of the group (b1) and the compounds of the group (b2) in combination as the antibacterial antifungal agent fixation aid (B), the infiltration fixation amounts of the antibacterial antifungal agent (A) were greater by about 80% to about 100% than in the product of Comparative Example 1 containing no antibacterial antifungal agent fixation aid (B).

In the product of Example 13 produced by using two surfactants and two organic solvents selected from the compounds of the group (b1) and the compounds of the group (b2) in combination as the antibacterial antifungal agent fixation aid (B), the infiltration fixation amount of the antibacterial antifungal agent (A) was greater by about 97% than in the product of Comparative Example 1 containing no antibacterial antifungal agent fixation aid (B). In the product of Example 14 in which the total amount of the antibacterial antifungal agent fixation aid (B) was one fourth that in the product of Example 13, the filtration fixation amount of the antibacterial antifungal agent (A) was greater by 65% than in the product of Comparative Example 1 containing no antibacterial antifungal agent fixation aid (B).

### Examples 15 to 22

Treated products of interest were produced in substantially the same manner as in Example 1, except that the formulations of the treatment liquids were changed as shown in Tables 6 and 7. The products of Examples 15 to 22 were analyzed and evaluated in the aforementioned manner. The results of the analysis and the evaluation are shown below together with the formulations of the treatment liquids in Tables 6 and 7. As in Tables 3 to 5, data of the results of the analysis of the antibacterial antifungal agent fixation aid (B) is not shown in Tables 6 and 7.

TABLE 6

| | Example | | | | |
|---|---|---|---|---|---|
| | 15 | 16 | 17 | 18 | 19 |
| Type of fibers | Fibers 1 | Fibers 1 | Fibers 1 | Fibers 1 | Fibers 1 |

Formulation of treatment liquid (wt. %)

| A | Zinc Pyrithione | | 0.2 | 0.2 | 0.2 | 0.2 | 0.2 |
|---|---|---|---|---|---|---|---|
| B | b1 | Surfactant 1 | 1 | — | — | 1 | 1 |
| | | Surfactant 2 | — | — | — | — | — |
| | | Surfactant 3 | — | — | 1 | — | — |
| | b2 | Organic solvent 1 | — | 1 | — | — | 1 |
| | | Organic solvent 2 | — | — | 3 | 1 | — |
| | b3 | Aromatic compound 1 | — | — | 1 | — | — |
| | | Aromatic compound 2 | — | — | — | 1 | — |
| | | Aromatic compound 3 | — | — | — | — | 1 |
| | | Urea compound 1 | 2 | 2 | — | — | — |
| | | Urea compound 2 | — | — | — | — | — |

| | | | | | |
|---|---|---|---|---|---|
| Water | 96.8 | 96.8 | 94.8 | 96.8 | 96.8 |

Results of analysis

| | | | | | |
|---|---|---|---|---|---|
| Zinc pyrithione (mg/kg) | 276 | 280 | 398 | 335 | 308 |

Results of evaluation

| | | | | | |
|---|---|---|---|---|---|
| Antibacterial property 1 (before washing/after washing) | ∘/∘ | ∘/∘ | ∘/∘ | ∘/∘ | ∘/∘ |
| Antibacterial property 2 (before washing/after washing) | Δ/Δ | Δ/Δ | ∘/∘ | ∘/∘ | ∘/∘ |
| Antifungal property (before washing/after washing) | Δ/Δ | Δ/Δ | ∘/∘ | ∘/∘ | Δ/Δ |
| Increase ratio (%) | 151 | 153 | 217 | 183 | 168 |

TABLE 7

| | Example | | |
|---|---|---|---|
| | 20 | 21 | 22 |
| Type of fibers | Fibers 1 | Fibers 2 | Fibers 3 |

Formulation of treatment liquid (wt.%)

| A | Zinc Pyrithione | | 0.2 | 0.2 | 0.2 |
|---|---|---|---|---|---|
| B | b1 | Surfactant 1 | 1 | — | — |
| | | Surfactant 4 | 1 | — | — |
| | | Surfactant 5 | — | 0.5 | 0.5 |
| | b2 | Organic solvent 1 | 3 | 3 | 3 |
| | | Organic solvent 2 | — | — | — |
| | b3 | Aromatic compound 1 | — | 0.5 | 0.5 |
| | | Aromatic compound 4 | 1 | — | — |
| | | Urea compound 2 | — | 0.5 | 0.5 |

| | | | |
|---|---|---|---|
| Water | 93.8 | 95.3 | 95.3 |

Results of analysis

| | | | |
|---|---|---|---|
| Zinc pyrithione (mg/kg) | 365 | 246 | 386 |

Results of evaluation

| | | | |
|---|---|---|---|
| Antibacterial property 1 | ○/○ | ○/○ | ○/○ |
| (before washing/after washing) | | | |
| Antibacterial property 2 | ○/○ | Δ/Δ | ○/○ |
| (before washing/after washing) | | | |
| Antifungal property | ○/○ | Δ/Δ | ○/○ |
| (before washing/after washing) | | | |
| Increase ratio (%) | 199 | 164 | 243 |

The above results indicate that, in the product of Example 15 produced by using a single surfactant selected from the compounds of the group (b1) and a single urea compound selected from the compounds of the group (b3) in combination as the antibacterial antifungal agent fixation aid (B), the infiltration fixation amount of the antibacterial antifungal agent (A) was greater by not less than 50% as compared with the product of Comparative Example 1 containing no antibacterial antifungal agent fixation aid (B).

In the product of Example 16 produced by using a single organic solvent selected from the compounds of the group (b2) and a single urea compound selected from the compounds of the group (b3) in combination as the antibacterial antifungal agent fixation aid (B), the infiltration fixation amount of the antibacterial antifungal agent (A) was greater by not less than 50% as compared with the product of Comparative Example 1 containing no antibacterial antifungal agent fixation aid (B).

In the products of Examples 17 to 20 each produced by using at least one compound selected from the compounds of the group (b1), at least one compound selected from the compounds of the group (b2), and at least one compound selected from the compounds of the group (b3) in combination as the antibacterial antifungal agent fixation aid (B), the infiltration fixation amounts of the antibacterial antifungal agent (A) were greater by about 60% to about 120% than the product of Comparative Example 1 containing no antibacterial antifungal agent fixation aid (B).

In the products of Examples 21 and 22 each produced by using four compounds selected from the compounds of the groups (b1), (b2), and (b3) in combination as the antibacterial antifungal agent fixation aid (B), the amounts of the antibacterial antifungal agent (A) infiltration-fixed in Fibers 2 and Fibers 3 were greater by about 60% to about 140% than in the products of Comparative Examples 2 and 3 each containing no antibacterial antifungal agent fixation aid (B).

While specific forms of the embodiments of the present disclosure have been shown in the aforementioned examples, the examples are merely illustrative but not limitative. It is contemplated that various modifications apparent to those skilled in the art could be made within the scope of the disclosure.

The present disclosure is applicable to fiber structures including polyester fibers and required to have highly washing-durable antibacterial and antifungal properties.

1. An antibacterial antifungal fiber structure comprising:
a polyester mixed fiber structure, the polyester mixed fiber structure comprising a polyester fiber and at least one non-polyester fiber, and
an antibacterial antifungal agent (A) and an antibacterial antifungal agent fixation aid (B) contained in the polyester mixed fiber structure,
wherein the antibacterial antifungal agent (A) comprises a pyridine antibacterial antifungal agent,
wherein the antibacterial antifungal agent fixation aid (B) comprises at least one compound selected from the group consisting of:
(b1) a first group comprising a surfactant;
(b2) a second group comprising an organic solvent; and
(b3) a third group comprising an aromatic compound and a urea compound, and
wherein the antibacterial antifungal agent (A) is fixed together with the antibacterial antifungal agent fixation aid (B) in fibers of the polyester mixed fiber structure.

2. The antibacterial antifungal fiber structure according to claim 1,
wherein the antibacterial antifungal agent (A) is present in an amount of 200 to 20,000 mg/kg based on a weight of the antibacterial antifungal fiber structure,
wherein the antibacterial antifungal agent fixation aid (B) is, present in an amount of 1 to 500 mg/kg based on the weight of the antibacterial antifungal fiber structure.

3. The antibacterial antifungal fiber structure according to claim 1, wherein the antibacterial antifungal agent (A) comprises a pyridine metal complex.

4. The antibacterial antifungal fiber structure according to claim 1, wherein the first group (hi) of the antibacterial antifungal agent fixation aid (B) comprises at least one selected from surfactants represented by the following formulae (1) and (2):
R¹—O—(R²O)ₙ—H (1)
wherein R¹ is C₈ to C₁₈ alkyl group, and R² is alkylene group; and
ϕ-O—(R³O)ₙ—H (2)
Wherein ϕ is polycyclic phenyl group, and R³ is alkylene group.

5. The antibacterial antifungal fiber structure according to claim 1, wherein the third group (b3) of the antibacterial antifungal agent fixation aid (B) comprises at least one selected from the group consisting of aromatic compounds and urea compounds represented by the following formulae (3) to (8): 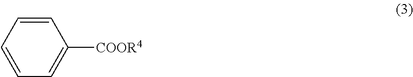
wherein R⁴ is alkyl group; 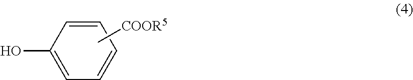
wherein R⁵ is alkyl group; 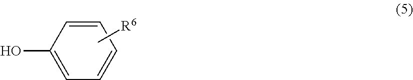
wherein R⁶ is alkyl group; 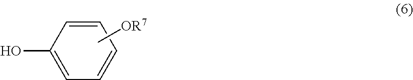
wherein R⁷ is alkyl group; 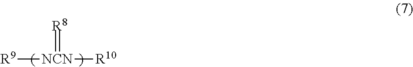
wherein R⁸ is oxygen atom or sulfur atom, and R⁹ and R¹⁰ are each alkyl group or hydrogen atom; and 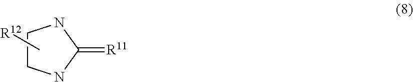
wherein R¹¹ is oxygen atom or sulfur atom, and R¹² is alkyl group or hydrogen atom.

6. The antibacterial antifungal fiber structure according to claim 1, wherein the antibacterial antifungal agent fixation aid (B) comprises at least two compounds selected from among all compounds of the first group (b1), the second group (b2), and the third group (b3).

7. The antibacterial antifungal fiber structure according to claim 1, wherein the antibacterial antifungal agent fixation aid (B) comprises at least one compound selected from the first group (b1) and at least one compound selected from the second group (b2).

8. The antibacterial antifungal fiber structure according to claim 1, wherein the antibacterial antifungal agent fixation aid (B) comprises at least one compound selected from the first group (b1) and at least one compound selected from the third group (b3).

9. The antibacterial antifungal fiber structure according to claim 1, wherein the antibacterial antifungal agent fixation aid (B) comprises at least one compound selected from the second group (b2) and at least one compound selected from the third group (b3).

10. The antibacterial antifungal fiber structure according to claim 1, wherein the antibacterial antifungal agent fixation aid (B) comprises at least one compound selected from the first group (b1), at least one compound selected from the second group (b2), and at least one compound selected from the third group (b3).
